(19) United States
(12) Patent Application Publication
(10) Pub. No.: US 2022/0303689 A1
(43) Pub. Date: Sep. 22, 2022

(54) SYSTEM AND METHOD FOR IMPROVING STEREOPHONIC SOUND

(71) Applicants: Inventec (Pudong) Technology Corporation, Shanghai (CN); INVENTEC CORPORATION, Taipei City (TW)

(72) Inventor: Kuo-Chi TING, TAIPEI CITY (TW)

(21) Appl. No.: 17/335,047

(22) Filed: May 31, 2021

(30) Foreign Application Priority Data
Mar. 16, 2021 (CN) 202110282456.1

(51) Int. Cl. H04R 5/04; H04R 5/027; H04S 1/00; H04R 5/02

(52) U.S. Cl. CPC H04R 5/04; H04R 5/027; H04S 1/00; H04R 5/02

(57) ABSTRACT

The present disclosure discloses a system for improving stereophonic sound, including a filter, a first speaker, a second speaker, a microphone, and a processor. The processor is configured to apply a filter matrix on an input signal to generate a filtered sound signal. The first speaker is electrically connected to the filter and emits a first sound signal according to the filtered sound signal. The second speaker is electrically connected to the filter and emits a second sound signal according to the filtered sound signal. The microphone is configured to receive the first and the second sound signal to obtain an actual sound signal. The processor is configured to compare the actual sound signal with a desired sound signal and obtain a sound signal error, and to adjust the filter matrix according to the sound signal error so that the actual sound signal approximates the desired sound signal.

### CROSS-REFERENCE TO RELATED APPLICATION

This application claims priority to China Application Serial Number 202110282456.1, filed Mar. 16, 2021, which is herein incorporated by reference in its entirety.

### BACKGROUND

### Field of Invention

The present invention relates to a system and a method both for improving stereophonic sound. More particularly, the present invention relates to a system and a method for improving stereophonic sound which include a filter, a first speaker, a second speaker, a microphone, and a processor.

### Description of Related Art

Most laptop has two speakers, and the sound from a left speaker and the sound from a right speaker interfere with each other when they travel to the vicinity of a user's head. The user's left ear receives not only the sound from the left speaker, and the user's right ear receives not only the sound from the right speaker, so the sound heard by the user does not feel stereophonic. Generally, this situation can be resolved through crosstalk cancellation, yet it is hard to come up with great crosstalk cancellation design for laptops with two speakers.

### SUMMARY

The invention provides a system for improving stereophonic sound, including a filter, a first speaker, a second speaker, a microphone, and a processor. The filter is configured to apply a filter matrix to an input signal to generate a filtered sound signal. The first speaker is electrically connected to the filter. The first speaker emits a first sound signal according to the filtered sound signal. The second speaker is electrically connected to the filter. The second speaker emits a second sound signal according to the filtered sound signal. The microphone is configured to receive the first sound signal and the second sound signal and obtain an actual sound signal. The processor is configured to compare the actual sound signal with a desired sound signal to obtain a sound error, and adjust the filter matrix according to the sound error so that the actual sound signal is approximate to the desired sound signal and the sound error has a minimum, wherein the adjusted filter matrix is an optimized filter matrix.

The invention also provides a method for improving stereophonic sound, including: applying a filter matrix to an input signal to generate a filtered sound signal; emitting a first sound signal through a first speaker according to the filtered sound signal; emitting a second sound signal through a second speaker according to the filtered sound signal; receiving the first sound signal and the second sound signal and obtaining an actual sound signal; comparing the actual sound signal with a desired sound signal and obtaining a sound error; and adjusting the filter matrix according to the sound error so that the actual sound signal is approximate to the desired sound signal and the sound error has a minimum, wherein the adjusted filter matrix is an optimized filter matrix.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram illustrating a system for improving stereophonic sound according to some embodiments of the present disclosure.

FIG. 2 is a block diagram of a system for improving stereophonic sound according to some embodiments of the present disclosure.

FIG. 3 is a diagram illustrating the performing of crosstalk cancellation by using two speakers and one microphone according to some embodiments of the present disclosure.

FIG. 4 is a waveform diagram illustrating waveforms of an input signal, a first sound signal, a second sound signal, a desired sound signal, and a sound error according to some embodiments of the present disclosure.

FIG. 5 is a flowchart of a method for improving stereophonic sound according to some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The terms used in this specification generally have their ordinary meanings in the art, within the context of the invention, and in the specific context where each term is used. As used in the present disclosure, the terms “comprising,” “including,” “having,” “containing,” “involving,” and the like are to be understood to be open-ended, i.e., to mean including but not limiting to. In addition, as used in the present disclosure, the term “and/or” includes any and all combinations of one or more of the associated listed items.

It will be understood that when an element is referred to as being “connected to,” “coupled to,” or “electrically connected to” another element, it can be directly connected or coupled to the other element or intervening elements may be present. In contrast, when an element is referred to as being “directly connected to,” “directly coupled to,” or “directly electrically connected to” another element, there is no intervening element present. In addition, when an element is referred to as being “communicatively connected to” another element, it can be indirectly or directly connected to the other element through wire or wireless communication. Moreover, it will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

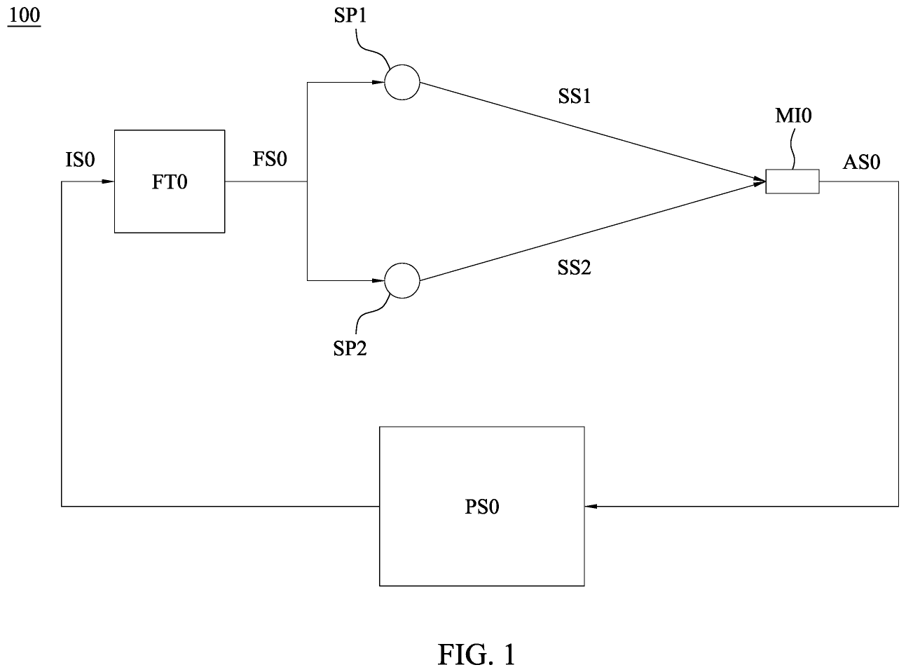

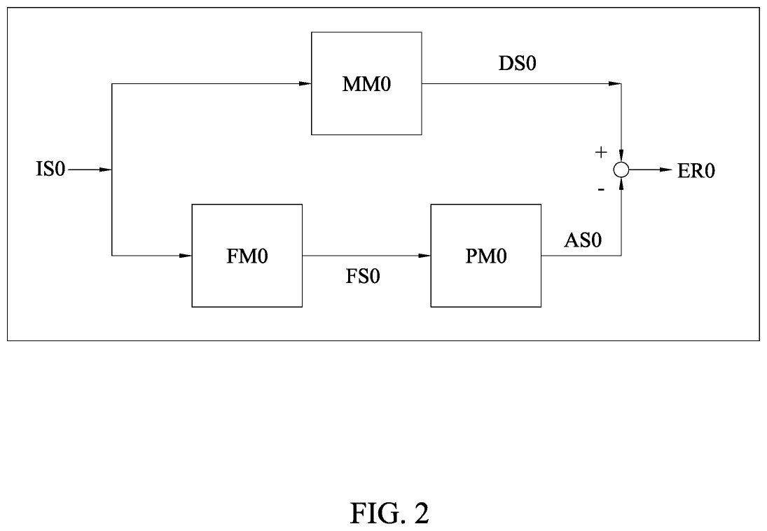

The present disclosure discloses a system for improving stereophonic sound. Please refer to FIG. 1 and FIG. 2. FIG. 1 is a diagram illustrating a system 100 for improving stereophonic sound according to some embodiments of the present disclosure. FIG. 2 is a block diagram of the system 100 for improving stereophonic sound according to some embodiments of the present disclosure. The system 100 includes a filter FT0, a first speaker SP1, a second speaker SP2, a microphone MI0, and a processor PS0. The filter FT0 is electrically connected to the processor PS0. The first speaker SP1 is electrically connected to the filter FT0. The second speaker SP2 is electrically connected to the filter FT0. The microphone MI0 is electrically connected to the processor PS0. The filter FT0 has a filter matrix FM0.

The following paragraphs describe the connection relationship between the elements of the system 100. The determination and generation of signals will be described after.

First, the processor PS0 transmits an input signal IS0 to the filter FT0. The filter FT0 applies the filter matrix FM0 to the input signal IS0 and generates a filtered sound signal FS0.

Then, the filter FT0 transmits the filtered sound signal FS0 to the first speaker SP1 and the second speaker SP2. The first speaker SP1 emits a first sound signal SS1 according to the filtered sound signal FS0. The second speaker SP2 emits a second sound signal SS2 according to the filtered sound signal FS0.

Further, the microphone MI0 receives the first sound signal SS1 and the second sound signal SS2 at the same time and obtains an actual sound signal AS0.

Finally, the processor PS0 compares the actual sound AS0 signal with a desired sound signal DS0. The difference between the actual sound signal AS0 and the desired sound signal DS0 is a sound error ER0. The filter FT0 adjusts the filter matrix FM0 according to the sound error ER0 so that the actual sound signal AS0 is approximate to the desired sound signal DS0 and the sound error ER0 has a minimum. When the sound error ER0 reaches its minimum, the filter matrix FM0 is an optimized filter matrix.

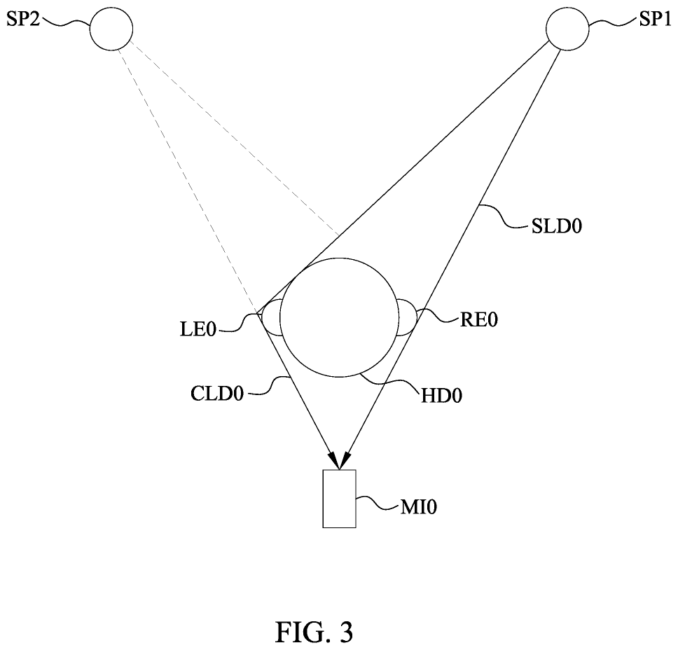

The following paragraphs describe how the desired sound signal DS0 is determined. Please refer to FIG. 3. FIG. 3 is a diagram illustrating the performing of crosstalk cancellation by using two speakers and one microphone according to some embodiments of the present disclosure. In one embodiment of the present disclosure, the first speaker SP1 and the microphone MI0 are separated by a straight-line distance SLD0 as shown in FIG. 3, and the second speaker SP2 and the microphone MI0 are separated also by the straight-line distance SLD0 (not indicated in FIG. 3). To make the audio of a device with two speakers (e.g., a laptop with two speakers) sound stereophonic, only the sound from the right speaker of the device should be received by the user's right ear, and only the sound from the left speaker of the device should be received by the user's left ear. In the embodiment shown in FIG. 3, the first speaker SP1 represents a right speaker of a device, and the second speaker SP2 represents a left speaker of the device. In order to achieve the stereophonic sound effect mentioned above, the embodiment attempts to cancel out the sound which comes from the first speaker SP1, bypasses a user's head HD0, and then travels to a user's left ear LE0 (i.e., the sound travels from the first speaker SP1 to the user's left ear LE0) and the sound which comes from the second speaker SP2, bypasses the user's head HD0, and then travels to a user's right ear RE0 (i.e., the sound travels from the first speaker SP2 to the user's left ear RE0). By this way, the user's right ear RE0 receives only the sound from the first speaker SP1, and the user's left ear LE0 receives only the sound from the second speaker SP2.

Below describes how to cancel out the sound of the first speaker SP1 which travels to the left ear LE0 and the sound of the second speaker SP2 which travels to the right ear RE0. Because the distance between the first speaker SP1 and the head HD0 is the same as the distance between the second speaker SP2 and the head HD0, and the distance between the first speaker SP1 and the microphone MI0 is the same as the distance between the second speaker SP2 and the microphone MI0, the following paragraphs describe only the cancellation of the sound of the first speaker SP1 which travels to the left ear LE0. The sound of the second speaker SP2 which travels to the right ear RE0 can be cancelled by the same way.

In general, the system 100 first determines the waveforms and the phases of the desired sound signal DS0 and the sound error ER0, monitors the actual sound signal AS0, and adjusts the filter matrix FM0 to lower the sound error ER0 to its minimum and cancel out the sound error ER0 as much as possible. As the system 100 intends that the right ear RE0 should receive only the sound from the first speaker SP1 and the left ear LE0 should receive only the sound from the second speaker SP2, the desired sound signal consists of these two sounds (i.e., the sound which comes from the first speaker SP1 and travels along the straight-line distance SLD0 and the sound which comes from the second speaker SP2 and travels along a direction of a straight line between the second speaker SP2 and the left ear LE0). On the other hand, as the system 100 intends the sound of the first speaker SP1 which travels to the left ear LE0 and the sound of the second speaker SP2 which travels to the right ear RE0 to be cancelled out, the sound signal ER0 is consists of these two sounds. Please refer to FIG. 3 again. The sound of the first speaker SP1 which travels to the right ear RE0 is a constituting part of the desired sound signal DS0, and the sound of the first speaker SP1 which travels to the left ear LE0 is a constituting part of the sound error ER0. Because the distances for which these two sounds travel are different, their phases are different. The system 100 thus can distinguish these two sounds by using the microphone MI0.

The sound of the first speaker SP1 which travels to the right ear RE0 will travel along the straight-line distance SLD0 to the right ear RE0 and then continue to travel along the direction of the straight-line distance SLD0 to the microphone MI0. The sound of the first speaker SP1 which travels to the left ear LE0 will travel along the path of a curve-line distance CLD0, first to the left ear LE0 and then to the microphone MI0. It takes time for the sound of the first speaker SP1 to travel to the microphone MI0, and because the curve-line distance CLD0 is greater than the straight-line distance SLD0 (because the sum of any 2 sides of a triangle must be greater than the length of the third side), the time required for the sound of the first speaker SP1 to travel along the path of the curve-line distance CLD0 to the microphone MI0 is longer than the time required for the sound of the first speaker SP1 to travel along the path of the straight-line distance SLD0 to the microphone MI0.

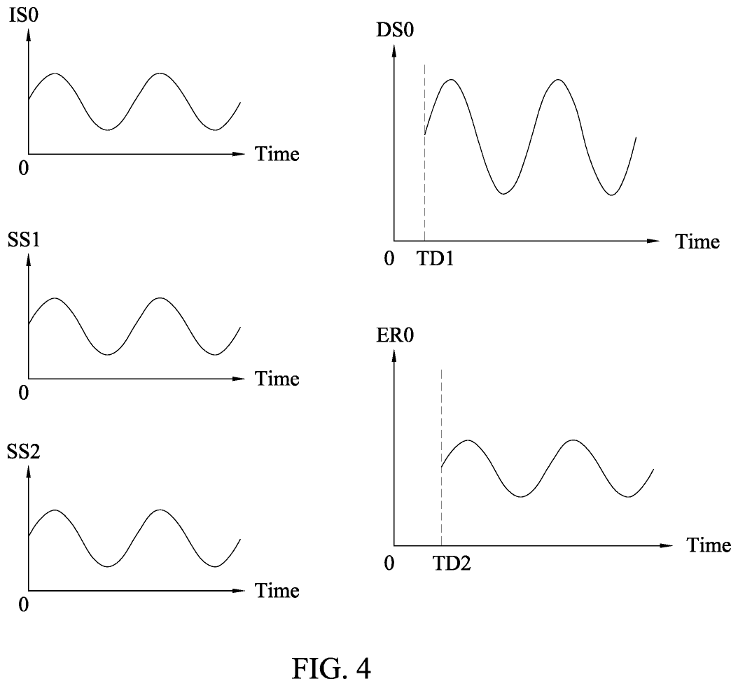

Please refer to FIG. 4. FIG. 4 is a waveform diagram illustrating the waveforms of the input signal IS0, the first sound signal SS1, the second sound signal SS2, the desired sound signal DS0, and the sound error ER0 according to some embodiments of the present disclosure. In FIG. 4, it should be understood that all of the origins in the waveform diagrams of the input signal IS0, the first sound signal SS1, the second sound signal SS2, the desired sound signal DS0, and the sound error ER0 (indicated as “0” in the five waveform diagrams) represent the same time, i.e., the time when the filter FT0 receives the input signals from the processor PS0. In one embodiment of the present disclosure, the input signal IS0, the first sound signal SS1, and the second sound signal SS2 have the same waveforms and no phase difference with each other; the desired sound signal DS0 has an amplitude larger than the amplitude of the input signal IS0, and because of a first time delay TD1 (i.e., the time required for the sound of the first speaker SP1 to travel along the path of the straight-line distance SLD0 to the microphone MI0), the desired sound signal DS0 has a phase difference when compared with the input signal IS0, the first sound signal SS1, or the second sound signal SS2. The sound error ER0 has the same amplitude as the amplitude of the input signal IS0, the first sound signal SS1, or the second sound signal SS2. The sound error ER0 has a second time delay (i.e., the time required for the sound of the first speaker SP1 to travel along the path of the curve-line distance CLD0 to the microphone MI0), wherein the second time delay TD2 is larger than the first time delay TD1, and thus the sound error ER0 has a phase difference when compared with the input signal IS0, the first sound signal SS1, or the second sound signal SS2.

Please refer to FIGS. 3 and 4 altogether. As mentioned above, the embodiments of the present disclosure intends that the right ear RE0 should receive only the sound from the first speaker SP1, and the left ear LE0 should receive only the sound from the second speaker SP2. That is, the desired sound signal DS0 consists of these two sounds, and thus the amplitude of the desired sound signal DS0 will be larger than the amplitude of the first sound signal SS1 or the second sound signal SS2, and the first time delay TD1 of the desired sound signal DS0 is the time required for the first sound signal SS1 or the second sound signal SS2 to travel along the path of the straight-line distance SLD0 to the microphone MI0. On the other hand, the sound error ER0 consists of the first sound signal SS1 which travels first to the left ear LE0 and then to the microphone MI0 and the second sound signal SS2 which travels first to the right ear RE0 and then to the microphone MI0, and the second time delay TD2 is the time required for the first sound signal SS1 or the second sound signal SS2 to travel along the path of the curve-line distance CLD0 to the microphone.

According to the amplitudes and phases of the signals involved in the present disclosure, the processor PS0 can set the desired sound signal DS0 according to the input signal IS0 and the first time delay TD1. For example, the amplitude of the desired sound signal DS0 can be two times of the amplitude of the input signal IS0 (i.e., the sum of the amplitudes of the first sound signal SS1 and the second sound signal SS2), and a first phase difference which the desired sound signal DS0 has can be determined by the first time delay TD1. On the other hand, the sound error ER0 has a second phase difference which can be determined by the second time delay TD2.

In sum, the system 100 determines the desired sound signal DS0, receives the actual sound signal AS0 and compares it with the desired sound signal DS0, adjusts the filter matrix FM0 so that the sound error ER0 between the actual sound signal AS0 and the desired sound signal DS0 has a minimum, and obtains the optimized filter matrix which has the greatest crosstalk cancellation performance. The technical mean previously described can also be understood through FIG. 2. The upper half of FIG. 2 represents the setting of a modeling matrix MM0 according to the desired sound signal DS0, wherein the modeling matrix MM0 is configured to be applied to the input signal IS0 to generate the desired sound signal DS0. The lower half of FIG. 2 represents the application of the filter matrix FM0 to the input signal IS0 to generate the filtered sound signal FS0 and the application of a propagation matrix PM0 to the filtered sound signal FS0 to generate the actual sound signal AS0, wherein the propagation matrix PM0 indicates the propagation relationship between the microphone MI0 and the first speaker SP1 or the second speaker SP2. The right side of FIG. 2 represents the comparison of the desired sound signal DS0 and the actual sound signal AS0, wherein the difference between them is the sound error ER0. Through adjusting and making the sound error ER0 reach its minimum, the filter matrix FM0 is the optimized filter matrix.

Please refer to FIG. 2 again. In one embodiment of the present disclosure, the processor PS0 can set the desired sound signal DS0 according to a delay matrix (not shown in FIG. 2) so that the working time of the filter FT0, the first speaker SP1, and/or the second speaker SP2 is taken into consideration. In other words, in this embodiment, by applying to the input signal IS0 the delay matrix and then the modelling matrix MM0, the desired sound signal DS0 which takes the working time into consideration can be generated.

In one embodiment of the present disclosure, the processor PS0 calculates and generates the propagation matrix PM0 according to the phase and amplitude of the actual sound signal AS0 and obtains the optimized filter matrix according to propagation matrix PM0. In this embodiment, because the propagation matrix PM0 is usually not a square matrix and cannot be solved by an inverse matrix, the Tikhonov Regularization algorithm can be used to obtain the optimized filter matrix.

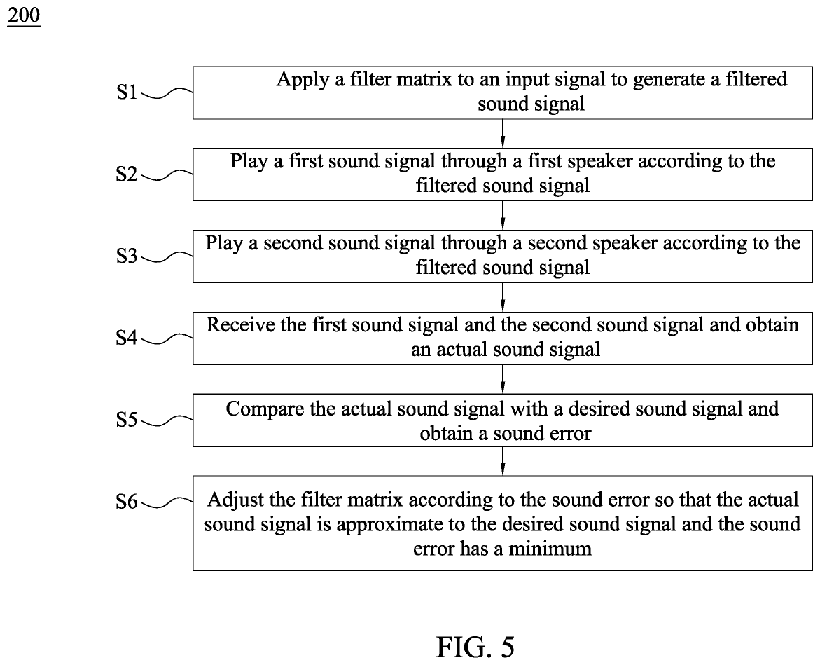

The present disclosure also discloses a method for improving stereophonic sound. Please refer to FIG. 5. FIG. 5 is a flowchart of a method 200 for improving stereophonic sound according to some embodiments of the present disclosure.

In a step S1, apply a filter matrix to an input signal to generate a filtered sound signal.

In a step S2, emit a first sound signal through a first speaker according to the filtered sound signal.

In a step S3, emit a second sound signal through a second speaker according to the filtered sound signal.

In a step S4, receive the first sound signal and the second sound signal and obtain an actual sound signal.

In a step S5, compare the actual sound signal with a desired sound signal and obtain a sound error.

In a step S6, adjust the filter matrix according to the sound error so that the actual sound signal is approximate to the desired sound signal and the sound error has a minimum, wherein the adjusted filter matrix is an optimized filter matrix.

In one embodiment of the present disclosure, the method 200 further includes generating the desired sound signal according to the input signal and a first phase difference. The first phase difference results from the time required for the first sound signal or the second sound signal to be received after emitted.

In one embodiment of the method 200, the sound error and the input signal have a second phase difference which differs from the first phase difference.

In one embodiment of the present disclosure, the method 200 further includes setting the desired sound signal according to a delay matrix so that the working time of the filter matrix, the first speaker, and/or the second speaker is taken into consideration.

In one embodiment of the present disclosure, the method 200 further includes calculating and generating a propagation matrix according to the phase and amplitude of the actual sound signal and obtaining the optimized filter matrix through Tikhonov Regularization algorithm according to the propagation matrix.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A system for improving stereophonic sound comprising:
a filter which is configured to apply a filter matrix to an input signal to generate a filtered sound signal;
a first speaker which is electrically connected to the filter, wherein the first speaker emits a first sound signal according to the filtered sound signal;
a second speaker which is electrically connected to the filter, wherein the second speaker emits a second sound signal according to the filtered sound signal;
a microphone which is configured to receive the first sound signal and the second sound signal and obtain an actual sound signal; and
a processor which is configured to compare the actual sound signal with a desired sound signal to obtain a sound error, and adjust the filter matrix according to the sound error so that the actual sound signal is approximate to the desired sound signal and the sound error has a minimum, wherein the adjusted filter matrix is an optimized filter matrix.

2. The system for improving stereophonic sound of claim 1, wherein the processor is configured to generate the desired sound signal according to the input signal and a first phase difference, the first speaker and the microphone are separated by a straight-line distance, the second speaker and the microphone are separated also by the straight-line distance, and the first phase difference results from a first time delay which is the time it takes for a sound to travel through the straight line distance.

3. The system for improving stereophonic sound of claim 2, wherein the sound error and the input signal have a second phase difference, and the second phase difference differs from the first phase difference.

4. The system for improving stereophonic sound of claim 1, wherein the processor sets the desired sound signal according to a delay matrix so that the working time of the filter, the first speaker, and/or the second speaker is taken into consideration.

5. The system for improving stereophonic sound of claim 1, wherein the processor generates a propagation matrix through calculation according to the phase and amplitude of the actual sound signal, and obtains the optimized filter matrix through Tikhonov Regularization algorithm according to the propagation matrix.

6. A method for improving stereophonic sound comprising:
applying a filter matrix to an input signal to generate a filtered sound signal;
emitting a first sound signal through a first speaker according to the filtered sound signal;
emitting a second sound signal through a second speaker according to the filtered sound signal;
receiving the first sound signal and the second sound signal and obtaining an actual sound signal;
comparing the actual sound signal with a desired sound signal and obtaining a sound error; and
adjusting the filter matrix according to the sound error so that the actual sound signal is approximate to the desired sound signal and the sound error has a minimum, wherein the adjusted filter matrix is an optimized filter matrix.

7. The method for improving stereophonic sound of claim 6, further comprising:
generating the desired sound signal according to the input signal and a first phase difference, wherein the first phase difference results from the time it takes for a sound to travel along the straight line distance.

8. The method for improving stereophonic sound of claim 7, wherein the sound error and the input signal have a second phase difference, and the second phase difference differs from the first phase difference.

9. The method for improving stereophonic sound of claim 6, further comprising:
setting the desired sound signal according to a delay matrix so that the working time of the filter matrix, the first speaker, and/or the second speaker is taken into consideration.

10. The method for improving stereophonic sound of claim 6, further comprising:
generating a propagation matrix through calculation according to the phase and amplitude of the actual sound signal; and
obtaining the optimized filter matrix through Tikhonov Regularization algorithm according to the propagation matrix.
